(19) United States
(12) Patent Application Publication
(10) Pub. No.: US 2004/0230915 A1
(43) Pub. Date: Nov. 18, 2004

(54) System and method for improved distributed menu performance

(75) Inventors: Stephen M. Diering, Raleigh, NC (US); Joseph E. Firebaugh, Apex, NC (US); Niraj P. Joshi, Cary, NC (US); Robert C. Leah, Cary, NC (US)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/437,341

(22) Filed: May 13, 2003

(51) Int. Cl. G09G 5/00

(52) U.S. Cl. 715/810

(57) ABSTRACT

A method and system for creating a menu, upon a user's initial request, initially having only a first set of menu items and displaying a second set of menu items upon a user's subsequent request. After receiving the user's initial menu request, the first set of menu items is determined and displayed. The first set of menu items includes menu items that correspond to actions on the local computer, menu items that are frequently selected by the user, etc. If a request for additional menu items is received from the user, a second set of menu items is determined and displayed. The second set of menu items includes menu items that correspond to actions on one or more remote computers such as a server, menu items that are infrequently selected by the user, etc.

### BACKGROUND OF THE INVENTION

1. Technical Field

The present invention relates in general to a system and method for improving the performance of distributed menus. In particular, the present invention relates to a system and a method for creating menus that initially contain local actions. A second set of menu items corresponding to remote, or server, actions displayed upon subsequent user request.

2. Description of the Related Art

Typically, software applications provide a user with actions that are performed on the local computer on which the applications are running. Often, however, software applications provide the user with actions performed on other computers (for example, remote computers across a network). This has given rise to the need for distributed menus as part of the user interface for these software applications. Distributed menus contain menu items that correspond to actions on the local computer as well as actions that correspond to remote computers. The creation of distributed menus involves communication with the local workstation as well as communication with the remote computers. Communication with remote computers typically involves sending a request to the remote computers for a list of the menu items appropriate for the currently selected menu.

The speed with which distributed menus are created depends on the type of network connecting the remote computers to the local computer, the current traffic on the network, the capabilities of the individual computers, etc. Typically, the creation of the distributed menus is slow since it requires a roundtrip from the local computer to the remote computers and back. Often, the slow creation of the distributed menus gives the user the wrong impression that the software application running on the local computer is performing slowly or inefficiently.

In many instances, the user is interested only in executing a local action. However, regardless of whether the user is requesting the execution of a local or a remote action, the user must wait for the creation of the distributed menu before making a selection. In other words, even in cases where the user is only requesting the execution of a local action, the user must wait for the reception from the remote computers of the menu list.

What is needed, therefore, is a system and method that improves the efficiency of distributed menus that include both local and remote actions. What is further needed is a system and method that allows the user to retrieve a list of remotely available actions upon request.

### SUMMARY

It has been discovered that the aforementioned challenges can be addressed by a method and system that first create a menu having a first set of menu items that correspond to actions on a local computer. A second set of menu items that includes actions available from one or more remote computers is displayed upon request by the user. This procedure eliminates the wait for users who are only interested in executing local actions.

Upon receiving a user request to create a menu, the first set of menu items is determined. The user may send the request by clicking a pointing device over the title of the menu, by issuing an appropriate voice command to the computer, or by other appropriate methods. The first set of menu items includes menu items that correspond to actions on the local computer. The first set of menu items may also include menu items that are frequently selected by the user. The determined menu items are then displayed on the screen. In addition to the first set of menu items, a “more options” menu item is displayed in the menu. The “more options” menu item enables the user, by selecting the item, to request for the additional, remotely available menu items.

If a user request for additional menu items is received, a second set of menu items is determined. The second set of menu items may include menu items that correspond to actions on one or more remote computers such as a server. The second set of menu items may also include menu items that are infrequently selected by the user. The “more options” menu item is replaced by the second set of menu items to create the complete menu.

To determine the second set of menu items that includes remote actions, a request for a list of the items is sent to the remote computers over the network connecting the local computer to the remote computers. After receiving the request, the remote computers determine the appropriate menu items and return the information to the local computer. The information is received and the menu items are displayed to the user.

The user may have the option to choose between the initial creation of partial menus or the initial creation of complete menus. The user may be prompted to make a selection upon initial use of the software application or the capability may exist for the user to configure the selected preference at a later time. After the user selects a preference, the selected preference is received and stored in a memory location. The selected preference may be read from the memory location and the preference determined before a menu is to be created. If the user has opted for complete menus, the local and remote menu items are both determined and displayed upon a user's first menu request. If the user has opted for increased menu efficiency, locally available actions are initially displayed with remotely available actions retrieved and displayed only upon a user's second request.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a high-level diagram of a system for creating improved distributed menus;

FIG. 2 is a flowchart for creating a menu with a first set of items associated with local actions and for creating, on user request, a second set of items associated with remote, server actions;

FIG. 3 is a flowchart for determining a user's preferences related to the creation of distributed menus;

FIG. 4 is a flowchart for creating menus according to a user's preferences; and

FIG. 5 illustrates an information handling system that is a simplified example of a computer system capable of performing the operations described herein.

### DETAILED DESCRIPTION

The following is intended to provide a detailed description of an example of the invention and should not be taken to be limiting of the invention itself. Rather, any number of variations may fall within the scope of the invention defined in the claims following the description.

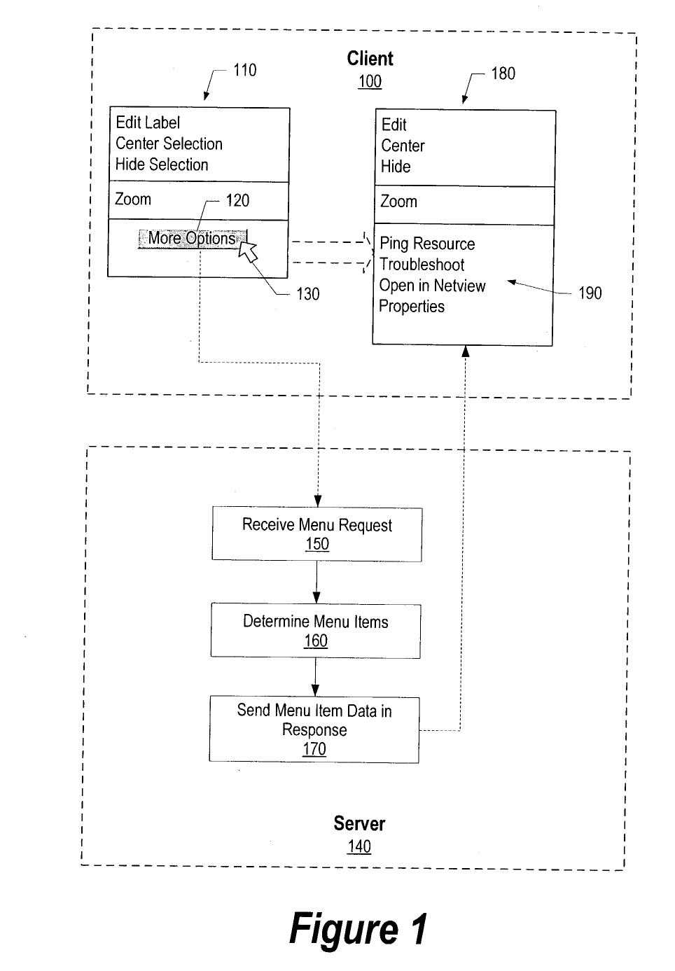

FIG. 1 is a high-level diagram of a system for creating improved distributed menus. The figure shows client 100, such as a local workstation, and server 140, such as a remote computer, connected to client 100 through a computer network. A user of client computer 100 requests menu 110, for example, by clicking a button on a pointer device while the pointer is over the title (or other identifier) of the menu, by issuing a voice command, pressing keyboard keys, other menu invocations methods familiar to those skilled in the art. The menu includes items that correspond to local actions (actions that are performed on the local, client computer) and items that correspond to remote actions (actions that are performed by the remote, server computer). The menu is first populated with items that correspond to local actions since these items may be quickly retrieved from local client 100. In order not to delay the creation of the menu, menu items that correspond to remote actions are not initially displayed. As seen in initial menu 110, the menu initially contains only local menu items such as “edit label”, “center selection”, “hide selection”, and “zoom”. Remote menu items are not initially displayed, and “more options” menu item 120 is displayed instead. In response to the user clicking on “more options” menu item 120, remote items 190 are displayed in complete menu 180.

The user requests item 120 using cursor 130 that corresponds to movement of a pointing device or by using a keyboard or voice activated requests. The user's request is received by server 140 (step 150). The server determines a list of the remote menu items (step 160) and sends the list data to client 100 (step 170). After receiving the data, client 100 removes the “more options” menu item and adds the remote menu items 190 to menu 110 in order to create complete menu 180.

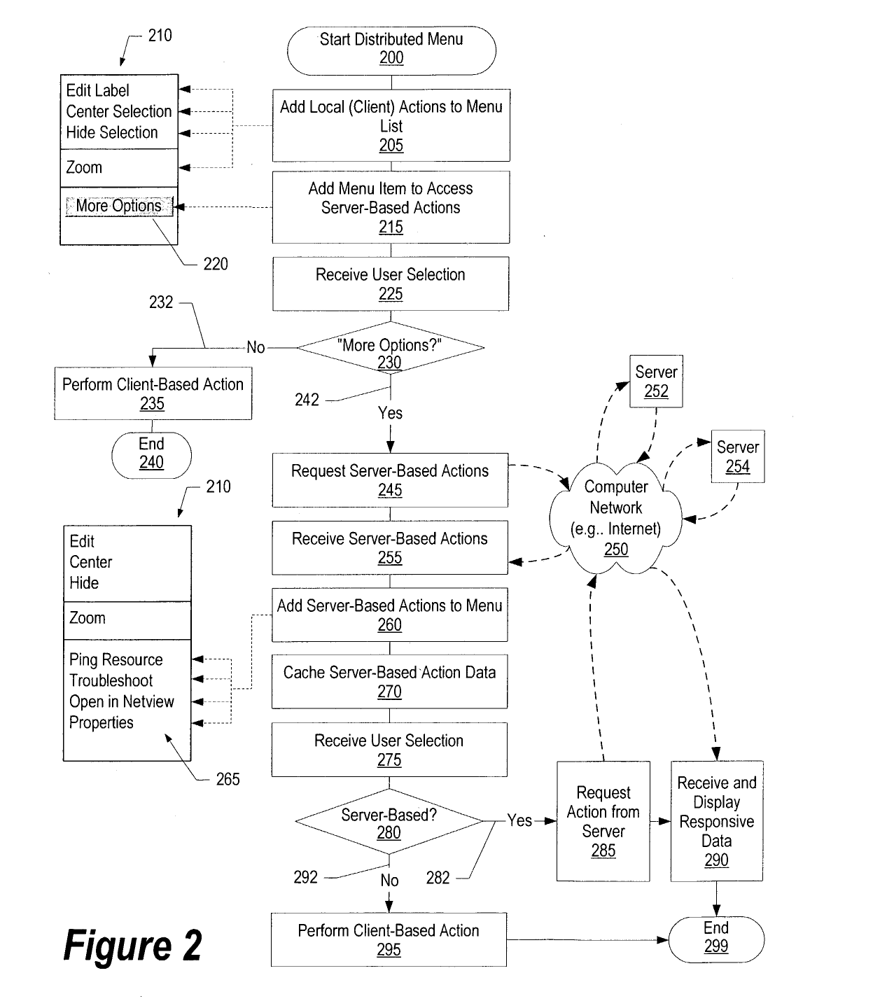

FIG. 2 is a flowchart for creating a menu with a first set of items associated with local actions and for creating, on user request, a second set of items associated with remote, server actions. Processing commences at 200 whereupon local menu items that correspond to local actions are added to the menu list to create partial menu 210 at step 205. Partial menu 210 initially contains menu items that correspond to actions that can be performed at the local computer and thus these menu items may be retrieved and displayed quickly. At step 215, “more options” item 220 is added to menu 210. In one embodiment, item 220 is only added to menu 210 in response to determining that remote actions are available. When the user selects “more options” item 220, the remaining menu items corresponding to actions performed at the server computer are displayed. At step 225, the user's request is received. A user may communicate the request, for example, by clicking on the “more options” item with a pointing device. In another embodiment, a user may select this option by speaking the appropriate voice command into a microphone connected to the computer or by pressing one or more keyboard keys. A determination is then made as to whether the user has requested the additional menu items by selecting “more options” menu item 220 (decision 230). If the user has selected an item that corresponds to a local action, decision 230 branches to “no” branch 232 and, at step 235, the corresponding action is performed. Processing subsequently ends at 240.

On the other hand, if the user has selected the “more options” item, decision 230 branches to “yes” branch 242 and at step 245 a request for the list of the remote menu items is sent to one or more servers (such as servers 252 and 254). The servers may be connected to the client through computer network 250 such as the Internet, a local area network, a wireless network, etc. The servers, after receiving the request, determine the appropriate menu items, and at step 255, menu items corresponding to remotely available actions are received by the local (client) computer. At step 260, the menu items received from the remote servers are added to menu 210 to create a complete menu. Menu 210 now contains the initially displayed local menu items as well as the later received and added remote menu items.

At step 270, the server-based action data corresponding to the remote menu items is cached in order to expedite future user requests of the server-based menu items. The user's menu selection is received at step 275. A determination is made as to whether the user has selected a menu item that corresponds to a server-based action (decision 280). If the user selected a menu item that corresponds to a client-based action, decision 280 branches to “no” branch 292 whereupon the client-based action is performed by the local computer at step 295 and processing subsequently ends at 299.

If instead the user has selected a menu item that corresponds to a server-based action, decision 280 branches to “yes” branch 282 whereupon, at step 285, the specific action is requested from a server connected to computer network 250. At step 290, the requested action is received and executed (displayed, etc.). Processing subsequently ends at step 299.

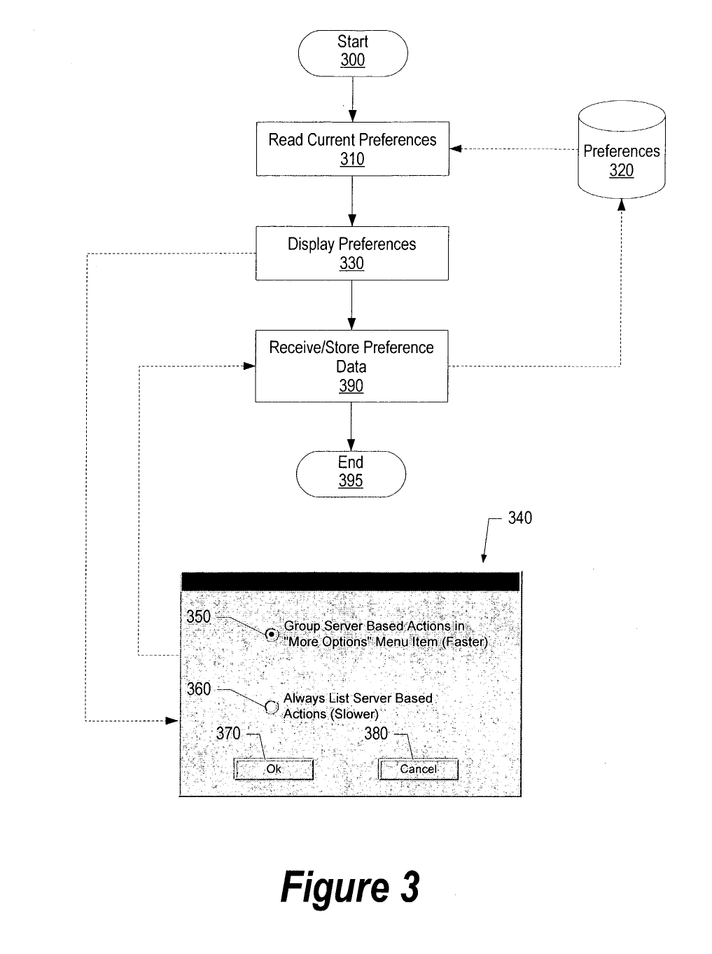

FIG. 3 is a flowchart for determining a user's preferences related to the creation of distributed menus. Processing commences at step 300 whereupon at step 310 the user's menu-creation preferences are retrieved from preferences storage 320. Prior to a user's setting the preferences, the preferences are set to a default value. After the current preferences are read, the preferences are displayed (step 330) to the user using dialog box 340.

A user may now select “Group Server Based Actions in ‘More Options’ Menu Item (Faster)” by selecting option button 350 or “Always List Server Based Actions (Slower)” by selecting option button 360. The first option corresponds to traditional, complete menus where both the local and remote menu items are initially displayed, and the second option corresponds to partial menus that initially contain only local menu items and become complete upon receiving a user's subsequent request. The latter choice improves the performance since the user does not have to wait for the reception of the list of the remote menu items from the remote servers. The user can accept the currently displayed selection by selecting “OK” button 370. The user can retain the previously selected option without saving any current changes by selecting “Cancel” button 380. If the user selects “OK” button 370, at step 390, the selected option is received and stored at preferences storage 320. If the user selects “Cancel” button 380, at step 390, the option currently stored in preferences 320 is retained. Processing ends at 395.

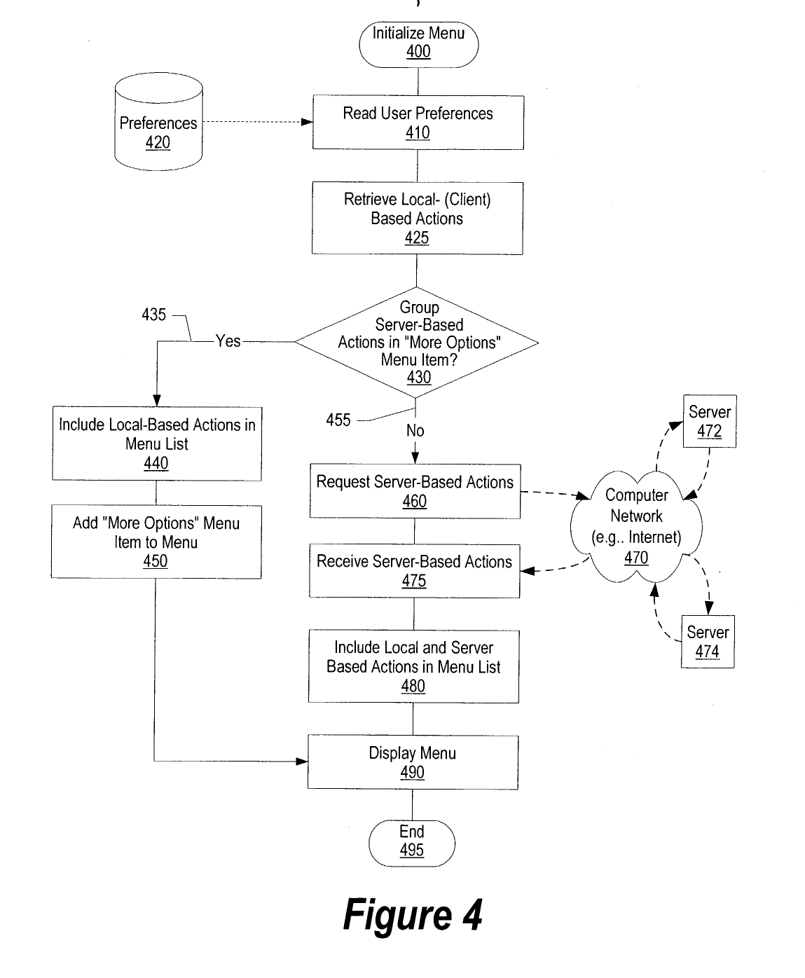

FIG. 4 is a flowchart for creating menus according to a user's preferences. Processing commences at 400 whereupon the user's preferences are read from preferences storage 420 at step 410. The user's preferences indicate whether the user prefers initially complete menus or menus that initially show menu items that correspond to actions on the local, client computer. At step 425, the menu items that correspond to local (client) actions are retrieved from the local computer. These menu items are displayed in the menu regardless of the user's preference.

A determination is then made as to whether the user has selected the partial menus options (decision 430). If the user has selected the partial menus option, decision 430 branches to “yes” branch 435 whereupon, at step 440, the menu items that correspond to local-based actions are included in the menu list. In addition, at step 450, the “more options” menu item is added to the menu list. By selecting the “more options” menu item, the additional menu items (those corresponding to server-based actions) are displayed. The created menu is displayed to the user at step 490 and processing ends at 495.

If instead the user has selected complete menus, decision 430 branches to “no” branch 455 whereupon, at step 460, the menu items that correspond to server-based actions are requested from the server or servers connected to the user's computer through computer network 470. In the example shown, servers 472 and 474 are connected to the local client through computer network 470 (for example, the Internet). At step 475, the menu items returned by servers 472 and 474 through computer network 470 are received, and at step 480, the menu list is created. The menu list now contains both local and server-based menu items. At step 490, the complete menu is displayed to the user, and processing ends at 495.

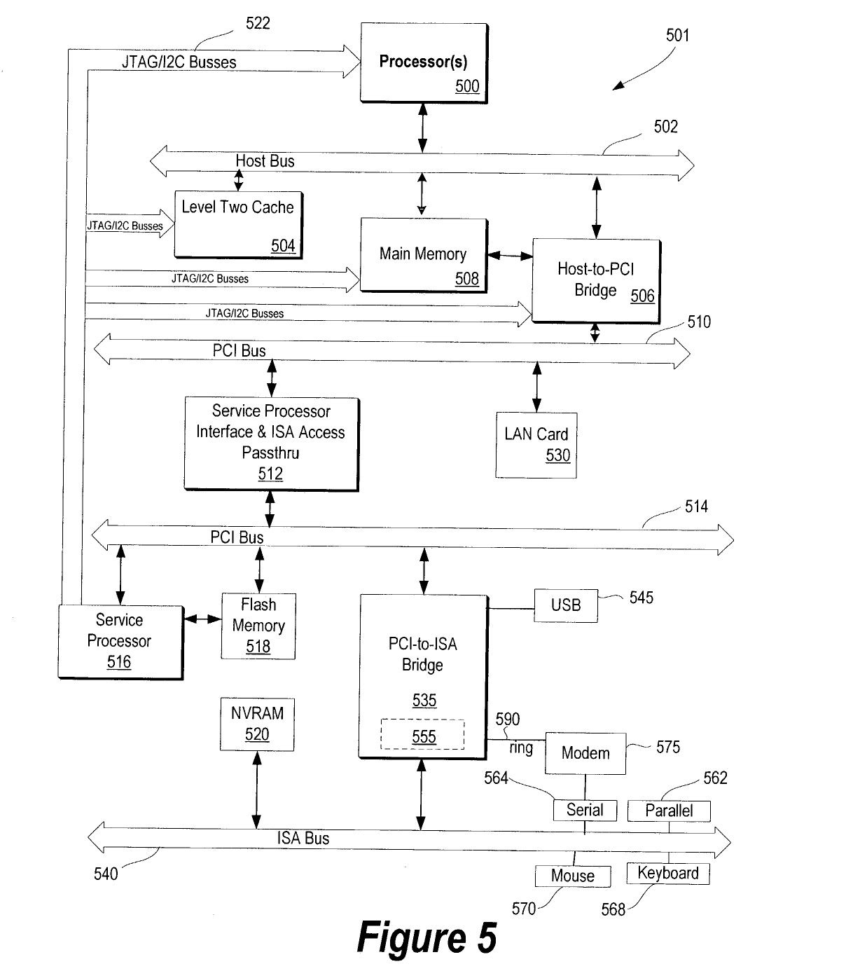

FIG. 5 illustrates information handling system 501 which is a simplified example of a computer system capable of performing the computing operations described herein. Computer system 501 includes processor 500 which is coupled to host bus 502. A level two (L2) cache memory 504 is also coupled to host bus 502. Host-to-PCI bridge 506 is coupled to main memory 508, includes cache memory and main memory control functions, and provides bus control to handle transfers among PCI bus 510, processor 500, L2 cache 504, main memory 508, and host bus 502. Main memory 508 is coupled to Host-to-PCI bridge 506 as well as host bus 502. Devices used solely by host processor(s) 500, such as LAN card 530, are coupled to PCI bus 510. Service Processor Interface and ISA Access Pass-through 512 provides an interface between PCI bus 510 and PCI bus 514. In this manner, PCI bus 514 is insulated from PCI bus 510. Devices, such as flash memory 518, are coupled to PCI bus 514. In one implementation, flash memory 518 includes BIOS code that incorporates the necessary processor executable code for a variety of low-level system functions and system boot functions.

PCI bus 514 provides an interface for a variety of devices that are shared by host processor(s) 500 and Service Processor 516 including, for example, flash memory 518. PCI-to-ISA bridge 535 provides bus control to handle transfers between PCI bus 514 and ISA bus 540, universal serial bus (USB) functionality 545, power management functionality 555, and can include other functional elements not shown, such as a real-time clock (RTC), DMA control, interrupt support, and system management bus support. Nonvolatile RAM 520 is attached to ISA Bus 540. Service Processor 516 includes JTAG and I2C busses 522 for communication with processor(s) 500 during initialization steps. JTAG/I2C busses 522 are also coupled to L2 cache 504, Host-to-PCI bridge 506, and main memory 508 providing a communications path between the processor, the Service Processor, the L2 cache, the Host-to-PCI bridge, and the main memory. Service Processor 516 also has access to system power resources for powering down information handling device 501.

Peripheral devices and input/output (I/O) devices can be attached to various interfaces (e.g., parallel interface 562, serial interface 564, keyboard interface 568, and mouse interface 570 coupled to ISA bus 540. Alternatively, many I/O devices can be accommodated by a super I/O controller (not shown) attached to ISA bus 540.

In order to attach computer system 501 to another computer system to copy files over a network, LAN card 530 is coupled to PCI bus 510. Similarly, to connect computer system 501 to an ISP to connect to the Internet using a telephone line connection, modem 575 is connected to serial port 564 and PCI-to-ISA Bridge 535.

While the computer system described in FIG. 5 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method for creating computer menus, the method comprising:
receiving a first request to create a menu;
determining a first set of menu items wherein the first set of menu items corresponds to local actions adapted to be performed by a local computer;
displaying the first set of menu items;
receiving a second request to display a second set of menu items, the second request corresponding to one of the first set of menu items;
determining a second set of menu items wherein the second set of menu items corresponds to remote actions adapted to be performed by one or more remote computers connected to the local computer via a computer network; and
displaying the second set of menu items.

2. The method of claim 1, wherein the first set of menu items includes a “more options” menu item, wherein the second request is received in response to the “more options” menu item being selected by a user.

3. The method of claim 2 further comprising:
removing the “more options” menu item in response to displaying the second set of menu items.

4. The method of claim 1, wherein the determining the
first set of menu items further comprises:
determining a set of menu items corresponding to actions frequently requested by a user, and wherein the determining the second set of menu items further comprises:
determining a set of menu items corresponding to actions infrequently requested by a user.

5. The method of claim 1, wherein the determining the second set of menu items comprises:
sending a request to the remote computers; and
receiving the second set of menu items from the remote computers.

6. The method of claim 1 further comprising:
prompting a user for a menu preference selection;
receiving the user's menu preference selection; and
storing the user's menu preference selection in a memory location.

7. The method of claim 6, wherein the prompting comprises asking the user to select a preference from the group consisting of always listing the second set of menu items and grouping the second set of menu items under a “more options” menu item.

8. The method of claim 7 further comprising:
reading the user's menu preference selection from the memory location; and
determining and displaying the first and second set of menus after the receiving of the first request to create the menu in response to the user's menu preference selection being to always list the second set of menu items.

9. An information handling system comprising:
one or more processors;
a memory accessible by the one or more processors;
a network interface connecting the information handling system through a network to one or more remote information handling systems;
one or more input devices that receive a first request to create a menu;
menu generation logic to generate a first set of menu items wherein the first set of menu items corresponds to local actions adapted to be performed by the information handling system;
a display device to display the first set of menu items;
a receiver to receive a second request to display a second set of menu items from one of the input devices, the second request corresponding to one of the first set of menu items;
menu creation logic to create a second set of menu items wherein the second set of menu items corresponds to remote actions adapted to be performed by the one or more remote information handling systems; and
display logic to display the second set of menu items on the display device.

10. The information handling system of claim 9, wherein:
menu logic to determine the first set of menu items, the one or more determinators determine a set of menu items corresponding to actions frequently requested by a user; and
menu logic to determine the second set of menu items, the one or more determinators determine a set of menu items corresponding to actions infrequently requested by a user.

11. The information handling system of claim 9, wherein the menu creation logic further comprises:
transmission logic for sending a request to the one or more remote information handling systems; and
a receiver to receive the second set of menu items from the one or more remote information handling systems over the network interface.

12. The information handling system of claim 9, wherein:
the one or more output devices display a prompt for a user to select a menu preference;
the one or more input devices receive the user's menu preference selection; and
the memory stores the selection.

13. A computer program product stored in a computer operable media for creating computer menus, the computer program product comprising:
means for receiving a first request to create a menu;
means for determining a first set of menu items wherein the first set of menu items corresponds to local actions adapted to be performed by a local computer;
means for displaying the first set of menu items;
means for receiving a second request to display a second set of menu items, the second request corresponding to one of the first set of menu items;
means for determining a second set of menu items wherein the second set of menu items corresponds to remote actions adapted to be performed by one or more remote computers connected to the local computer via a computer network; and
means for displaying the second set of menu items.

14. The computer program product of claim 13, wherein the first set of menu items includes a “more options” menu item, wherein the second request is received in response to the “more options” menu item being selected by a user.

15. The computer program product of claim 14, further comprising:
means for removing the “more options” menu item in response to displaying the second set of menu items.

16. The computer program product of claim 13, wherein the means for determining the first set of menu items further comprises:
means for determining a set of menu items corresponding to actions frequently requested by a user, and wherein the determining the second set of menu items further comprises a means for determining a set of menu items corresponding to actions infrequently requested by a user.

17. The computer program product of claim 13, wherein the means for determining the second set of menu items comprises:
means for sending a request to the remote computers; and
means for receiving the second set of menu items from the remote computers.

18. The computer program product of claim 13, the computer program product further comprising:
means for prompting a user for a menu preference selection;
means for receiving the user's menu preference selection; and
means for storing the user's menu preference selection in a memory location.

19. The computer program product of claim 18, wherein the means for prompting further comprises:
means for asking the user to select a preference from the group consisting of always listing the second set of menu items and grouping the second set of menu items under a “more options” menu item.

20. The computer program product of claim 13, the computer program product further comprising:
means for reading the user's menu preference selection from the memory location; and
means for determining and displaying the first and second set of menus after the receiving of the, first request to create the menu in response to the user's menu preference selection being to always list the second set of menu items.

21. A computer-implemented computer program product for creating computer menus, the computer program product comprising:
receiving a first request to create a menu;
determining a first set of menu items wherein the first set of menu items corresponds to local actions adapted to be performed by a local computer;
displaying the first set of menu items;
receiving a second request to display a second set of menu items;
determining a second set of menu items wherein the second set of menu items corresponds to remote actions adapted to be performed by one or more remote computers connected to the local computer via a computer network, the determining of the second set of menu items further comprising:
sending a request to the remote computers; and
receiving the second set of menu items from the remote computers; and
displaying the second set of menu items on a display device.

22. A computer program product stored in a computer operable media for creating computer menus, the computer program product comprising:
means for receiving a first request to create a menu;
means for determining a first set of menu items wherein the first set of menu items corresponds to local actions adapted to be performed by a local computer;
means for displaying the first set of menu items;
means for receiving a second request to display a second set of menu items;
means for determining a second set of menu items wherein the second set of menu items corresponds to remote actions adapted to be performed by one or more remote computers connected to the local computer via a computer network, the means for determining of the second set of menu items further comprising:
means for sending a request to the remote computers; and
means for receiving the second set of menu items from the remote computers; and
means for displaying the second set of menu items on a display device.
